(19) United States
(12) Patent Application Publication
(10) Pub. No.: US 2026/0135172 A1
(43) Pub. Date: May 14, 2026

(54) THREE-ELECTRODE COIN CELL AND METHOD FOR MANUFACTURING SAME

(71) Applicant: SAMSUNG SDI CO., LTD., Yongin-Si (KR)

(72) Inventors: Younghoon KO, Yongin-Si (KR); Soojin KIM, Yongin-Si (KR)

(21) Appl. No.: 19/338,629

(22) Filed: Sep. 24, 2025

(30) Foreign Application Priority Data
Nov. 11, 2024 (KR) 10-2024-0159070

(51) Int. Cl. H01M 10/48; H01M 50/109

(52) U.S. Cl. CPC H01M 10/48; H01M 50/109

(57) ABSTRACT

A three-electrode coin cell includes: a first electrode; a second electrode having a polarity different from that of the first electrode; a reference electrode to measure a potential of the first electrode; a case body accommodating the first electrode, the second electrode, and the reference electrode, and having one open side; and a cap plate on the open side of the case body. The first electrode and the reference electrode are spaced from each other on an inner bottom surface of the case body.

### CROSS-REFERENCE TO RELATED APPLICATION

The present application claims priority to and the benefit of Korean Patent Application No. 10-2024-0159070, filed on November 11, 2024, in the Korean Intellectual Property Office, the entire disclosure of which is incorporated by reference herein.

### BACKGROUND

### 1. Field

Aspects of embodiments of the present disclosure relate to a three-electrode coin cell, and a method for manufacturing the three-electrode coin cell.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

A secondary battery including a positive electrode and a negative electrode may be referred to as a two-electrode cell including a working electrode and a counter electrode. To measure a difference in a potential between the working electrode and the counter electrode, a three-electrode cell further including a reference electrode has been introduced.

The above information disclosed in this Background section is for enhancement of understanding of the background of the present disclosure, and therefore, it may contain information that does not constitute related (or prior) art.

### SUMMARY

To prevent a physical contact between a working electrode and a counter electrode of a comparative three-electrode cell, two separators are placed between the working electrode and the counter electrode, and a reference electrode is disposed between the two separators. Accordingly, it may be difficult to accurately measure the potential of the working electrode through the reference electrode, due to an excessive resistance that may be caused by the separators.

Embodiments of the present disclosure may be directed to a three-electrode coin cell, and a method for manufacturing the three-electrode coin cell.

These and other aspects and features of the present disclosure will be described in or will be apparent from the following description of embodiments of the present disclosure.

According to one or more embodiments of the present disclosure, a three-electrode coin cell includes: a first electrode; a second electrode having a polarity different from that of the first electrode; a reference electrode configured to measure a potential of the first electrode; a case body accommodating the first electrode, the second electrode, and the reference electrode, and having one open side; and a cap plate on the open side of the case body. The first electrode and the reference electrode are spaced from each other on an inner bottom surface of the case body.

In an embodiment, the three-electrode coin cell may further include an insulating coating layer on the inner bottom surface of the case body, and the reference electrode may be located on the insulating coating layer.

In an embodiment, an area of the insulating coating layer may be wider than an area of the reference electrode.

In an embodiment, an area of the reference electrode may be 4 mm² or less.

In an embodiment, a distance between the first electrode and the reference electrode may be 0.5 mm or less.

In an embodiment, the reference electrode may be closer to an inner side surface of the case body than the first electrode.

In an embodiment, the three-electrode coin cell may further include a single separator between the first electrode and the second electrode, and the second electrode may be located on the single separator and may overlap with the first electrode.

In an embodiment, the three-electrode coin cell may further include a wire having one end connected to the reference electrode, and another end located outside the case body.

In an embodiment, the wire may include: a first wire connected to the reference electrode; and a second wire connected to the first wire, and located adjacent to the case body. An outer surface of the second wire may be coated with an insulating material.

In an embodiment, a portion of the reference electrode may be folded as a folded portion of the reference electrode, and the first wire may be connected to the folded portion.

In an embodiment, a diameter of the wire may be 0.1 mm or less.

In an embodiment, the three-electrode coin cell may further include an insulating member including: a first insulating portion in contact with an inner side surface of the case body; and a second insulating portion protruding from the first insulating portion toward an inside of the case body.

In an embodiment, at least a portion of the second insulating portion may be located on at least a portion of the reference electrode.

In an embodiment, the three-electrode coin cell may further include a single separator on the first electrode, and an end of the single separator may be on a lower portion of the second insulating portion.

According to one or more embodiments of the present disclosure, a method of manufacturing a three-electrode coin cell includes: arranging a first electrode and a reference electrode with a distance therebetween on an inner bottom surface of a case body having one open side, the reference electrode for measuring a potential of the first electrode; placing a single separator on the first electrode; disposing a second electrode having a polarity different from that of the first electrode on the single separator; and positioning a cap plate on the open side of the case body.

In an embodiment, the arranging of the first electrode and the reference electrode may include: forming an insulating coating layer on the inner bottom surface of the case body; and placing the reference electrode on the insulating coating layer.

In an embodiment, the method may further include connecting one end of a wire to the reference electrode, and positioning another end of the wire outside the case body.

In an embodiment, the wire may include: a first wire connected to the reference electrode; and a second wire connected to the first wire, and located adjacent to the case body. An outer surface of the second wire may be coated with an insulating material.

In an embodiment, the method may further include accommodating an insulating member into the case body after the placing of the single separator, and the insulating member may include: a first insulating portion in contact with an inner side surface of the case body; and a second insulating portion protruding from the first insulating portion toward an inside of the case body.

In an embodiment, the accommodating of the insulating member into the case body may include placing an end of the single separator on a lower portion of the second insulating portion of the insulating member.

According to some embodiments of the present disclosure, a reference electrode of a three-electrode coin cell may be positioned horizontally adjacent to a first electrode, rather than between the first electrode and a second electrode. As a result, because there may be no interference from a separator, it may be possible to more accurately measure the potential of the first electrode through the reference electrode. In addition, the reference electrode may be placed on an insulating coating layer so that short-circuiting between the reference electrode and a case may be prevented or substantially prevented.

According to some embodiments of the present disclosure, a noise may be reduced in a profile of a voltage output by a three-electrode coin cell. In addition, a reference electrode may not be arranged between a working electrode and a counter electrode, so that an interference and side reactions of the reference electrode may be decreased. As a result, a high charge/discharge rate (C-rate) may be secured, and/or the voltage of the working electrode may be stably measured even in multiple experiments.

These and other aspects and features of the present disclosure will be described in or will be apparent from the following description of embodiments of the present disclosure.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is an exploded perspective view showing an example of a three-electrode coin cell according to an embodiment of the present disclosure.

FIG. 2 is a perspective view showing an example of a case body housing a first electrode and a reference electrode according to an embodiment of the present disclosure.

FIG. 3 is a plan view showing an example of a case body housing a first electrode and a reference electrode according to an embodiment of the present disclosure.

FIG. 4 is a cross-sectional view showing an example of a case body housing a first electrode and a reference electrode according to an embodiment of the present disclosure.

FIG. 5 is a perspective view showing an example of how a reference electrode is connected to a wire according to an embodiment of the present disclosure.

FIG. 6 is a cross-sectional view showing an example of how an insulating member is coupled according to an embodiment of the present disclosure.

FIG. 7 is a flowchart showing an example of a method of manufacturing a three-electrode coin cell according to an embodiment of the present disclosure.

FIG. 8 is a schematic diagram illustrating an example in which a first electrode and a reference electrode are located on an inner bottom surface of a case body according to an embodiment of the present disclosure.

FIG. 9 is a schematic diagram illustrating an example in which a single separator is located on a first electrode according to an embodiment of the present disclosure.

FIG. 10 is a schematic diagram illustrating an example in which an insulating member is located according to an embodiment of the present disclosure.

FIG. 11 is a schematic diagram illustrating an example in which a second electrode is located on a separator according to an embodiment of the present disclosure.

FIG. 12 is a schematic diagram illustrating an example in which a spacer and an elastic member are located according to an embodiment of the present disclosure.

FIG. 13 is a schematic diagram illustrating an example in which a cap plate is located on an open surface of a case body according to an embodiment of the present disclosure.

FIG. 14 is a graph illustrating an example of an output voltage profile using a three-electrode coin cell according to an embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when a layer or element is referred to as being “between” two layers, it can be the only layer between the two layers, or one or more intervening layers may also be present. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being "coupled" or "connected" to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of "may" when describing embodiments of the present disclosure relates to "one or more embodiments of the present disclosure." Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or "over" the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms "includes," "including," “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of local patent laws.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being "linked," "coupled," or "connected" to another component, the elements may be directly “coupled,” “linked” or "connected" to each other, or another component may be "interposed" between the components".

Throughout the specification, when "A and/or B" is stated, it means A, B or A and B, unless otherwise stated. That is, “and/or” includes any or all combinations of a plurality of items enumerated. When "C to D" is stated, it means C or more and D or less, unless otherwise specified.

The size and relative size of layers and areas depicted in the drawings may be exaggerated for convenience of illustration. In other words, the sizes shown in the drawings are provided for convenience of illustration, and are not limited thereto. In addition, the same reference numerals refer to the same components throughout the present disclosure.

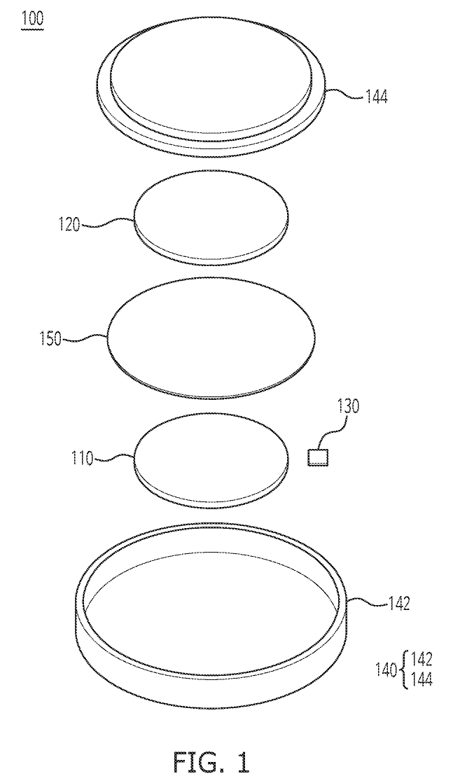

FIG. 1 is an exploded perspective view showing an example of a three-electrode coin cell 100 according to an embodiment of the present disclosure.

In an embodiment, the three-electrode coin cell 100 may include a first or negative electrode 110, a second or positive electrode 120 having a polarity different from that of the first electrode 110, and a reference electrode 130 for measuring a potential of the first electrode 110. In addition, the first electrode 110, the second electrode 120, and the reference electrode 130 may be accommodated in a case 140. The case 140 may include a case body 142 and a cap plate 144. The case body 142 may have one open side, and may accommodate the first electrode 110, the second electrode 120, and the reference electrode 130. The cap plate 144 may be disposed on the open side of the case body 142.

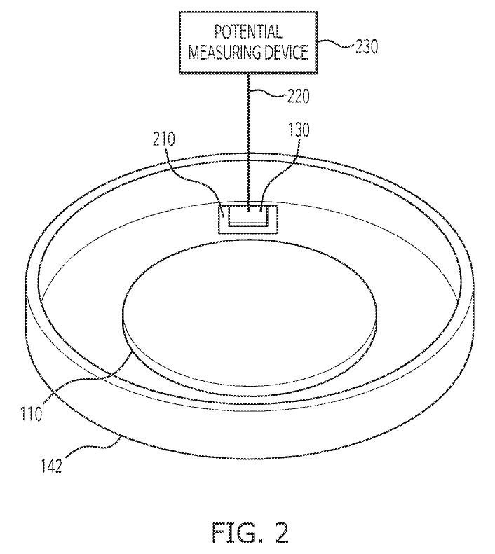

In an embodiment, the first electrode 110 and the reference electrode 130 may be spaced apart from each other on an inner bottom surface of the case body 142. In this case, the first electrode 110 may be arranged almost in the center of the case body 142, and the reference electrode 130 may be placed closer to an inner side surface or wall of the case body 142 than the first electrode 110. An example of how the reference electrode 130 is disposed within the case body 142 will be described in detail below with reference to FIGS. 2 to 4.

In an embodiment, the second electrode 120 may be placed on the first electrode 110. In this case, a single separator 150 may be positioned between the first electrode 110 and the second electrode 120. Accordingly, a smaller number of separators may be used or included than that of a comparative three-electrode coin cell.

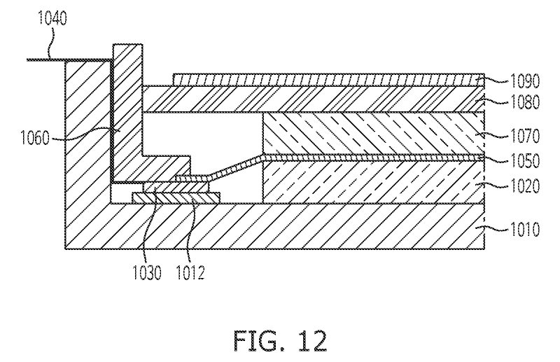

FIG. 1 shows the three-electrode coin cell 100 including the first electrode 110, the second electrode 120, the reference electrode 130, and the single separator 150, but the present disclosure is not limited thereto. For example, the three-electrode coin cell 100 may further include a spacer for suppressing a flow of a first electrode 1020 (e.g., see FIG. 12) and a second electrode 1070, and an elastic member for maintaining or substantially maintaining a pressure inside the cell in response to a volume change that may occur when the components in the three-electrode coin cell expand or contract. This will be described in detail below with reference to FIG. 12.

In the three-electrode coin cell described above, the reference electrode may be placed horizontally adjacent to the first electrode, rather than between the first electrode and the second electrode. Accordingly, because there may be no interference from the separator, it may be possible to more accurately measure the potential of the first electrode through the reference electrode. In addition, as the reference electrode is not arranged between a working electrode and a counter electrode, an interference and side reactions of the reference electrode may be reduced. As a result, a high charge/discharge rate (C-rate) may be secured using the three-electrode coin cell, and/or the voltage of the working electrode may be stably measured even in multiple experiments.

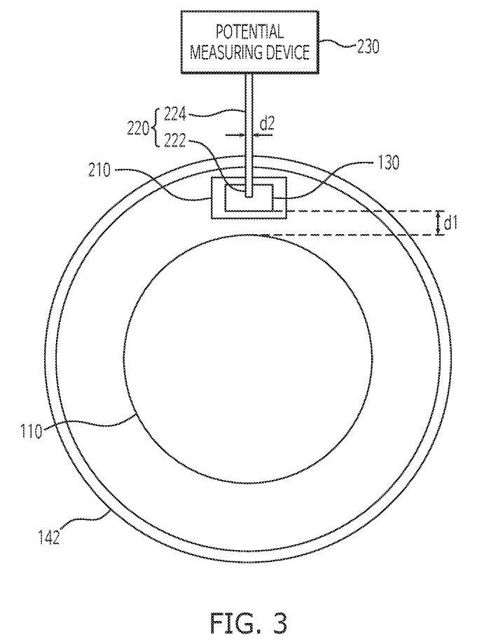

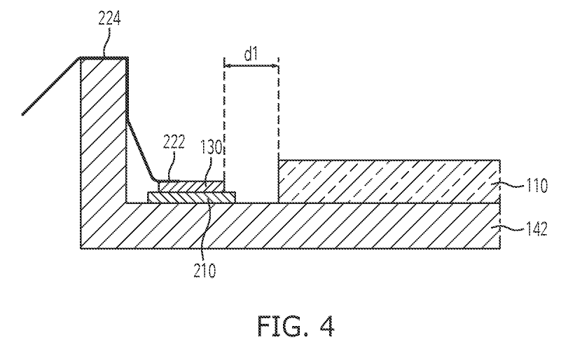

FIG. 2 is a perspective view showing an example of the case body 142 housing the first electrode 110 and the reference electrode 130 according to an embodiment of the present disclosure. FIG. 3 is a plan view showing an example of the case body 142 housing the first electrode 110 and the reference electrode 130 according to an embodiment of the present disclosure. FIG. 4 is a cross-sectional view showing an example of the case body 142 housing the first electrode 110 and the reference electrode 130 according to an embodiment of the present disclosure.

In an embodiment, the first electrode 110 and the reference electrode 130 may be accommodated in the case body 142. The first electrode 110 and the reference electrode 130 may be spaced apart from each other on the inner bottom surface of the case body 142. In addition, referring to FIGS. 3 and 4, on account of a voltage drop resulting from a distance between the first electrode 110 and the reference electrode 130, a distance d1 between the first electrode 110 and the reference electrode 130 may be 0.5 mm or less, but the present disclosure is not limited thereto.

In an embodiment, the reference electrode 130 may be placed on an insulating coating layer 210 formed on the inner bottom surface of the case body 142. In this case, considering a resistance resulting from the area of the reference electrode 130, the area of the reference electrode 130 may be 4 mm² or less, but the present disclosure is not limited thereto. In addition, the area of the insulating coating layer 210 may be wider than the area of the reference electrode 130. Accordingly, the reference electrode 130 may be electrically insulated from the inner bottom surface of the case body 142.

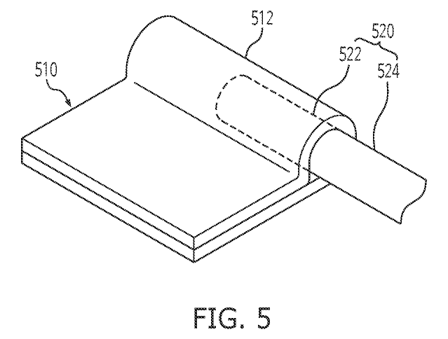

In an embodiment, the three-electrode coin cell may further include a wire 220 having one end connected to the reference electrode 130, and another end (e.g., an opposite end) placed outside the case body 142. The wire 220 may include a first wire 222 connected to the reference electrode 130, and a second wire 224 connected to the first wire 222 and positioned adjacent to the case body 142. An example of how the wire 220 is connected to the reference electrode 130 will be described in more detail below with reference to FIG. 5.

In an embodiment, an outer surface of the second wire 224 may be coated with an insulating material to be insulated from the case body 142. For example, an inner portion of the first wire 222 and the second wire 224 may be formed of copper, and the outer surface of the second wire 224 may be coated with an enamel, but the present disclosure is not limited thereto. In addition, referring to FIG. 3, a diameter d2 of the wire 220, or in more detail, the diameter d2 of the second wire 222, may be 0.1 mm or less to prevent or substantially prevent a leakage of an electrolyte inside the three-electrode coin cell.

In an embodiment, the other end of the wire 220 may be connected to a potential measuring device 230 located outside the case body 142. The potential measuring device 230 may measure the potential of the first electrode 110 through the reference electrode 130. For example, in some embodiments, the potential measuring device 230 may include a voltmeter, a multimeter, a potentiometer, and/or the like.

As a result, the reference electrode may be placed horizontally adjacent to the first electrode, rather than between the first electrode and the second electrode. Accordingly, because there may be no interference from a separator, it may be possible to more accurately measure the potential of the first electrode through the reference electrode. In addition, as the reference electrode is placed on the insulating coating layer, it may be possible to prevent or substantially prevent short circuiting between the reference electrode and the case.

FIG. 5 is a perspective view showing an example of how a reference electrode 510 is connected to a wire 520 according to an embodiment of the present disclosure. In an embodiment, the wire 520 may include a first wire 522 connected to the reference electrode 510, and a second wire 524 connected to the first wire 522 and positioned adjacent to the case body. In this case, unlike the first wire 522, an outer surface of the second wire 524 may be coated with an insulating material.

In an embodiment, the reference electrode 510 may include a folded portion 512 formed by folding a portion of the reference electrode 510. For example, the reference electrode 510 may be formed by folding a flat or substantially flat electrode plate including a conductive material, such as metal, to form the folded portion 512 including a through hole therein, and closely connecting the remaining portions of the electrode plate excluding the folded portion 512. In addition, the first wire 522 may be connected to the folded portion 512. In more detail, because the folded portion 512 may be formed by folding an electrode plate, it may include an empty space. In this case, the first wire 522 may be inserted into the empty space, so that the first wire 522 may be electrically connected to the folded portion 512.

FIG. 5 shows that the first wire 522 is connected to the reference electrode 510 through the folded portion 512, but the present disclosure is not limited thereto. For example, the first wire 522 may be connected to an upper surface of the reference electrode 510 having a flat or substantially flat shape through a conductive adhesive.

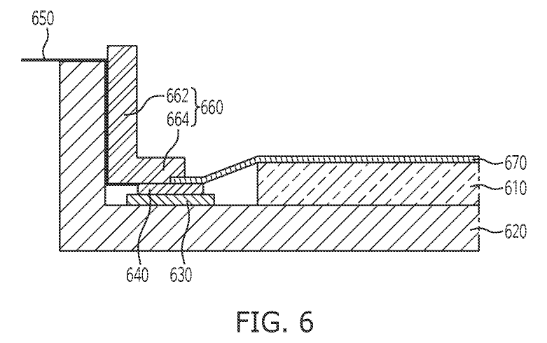

FIG. 6 is a cross-sectional view showing an example of how an insulating member 660 is coupled according to an embodiment of the present disclosure.

In an embodiment, a three-electrode coin cell may include a first electrode 610 accommodated in a case body 620, and a reference electrode 640 for measuring a potential of the first electrode 610. The first electrode 610 and the reference electrode 640 may be spaced apart from each other on an inner bottom surface of the case body 620. In addition, the reference electrode 640 may be placed on an insulating coating layer 630 formed on the inner bottom surface of the case body 620.

In an embodiment, the reference electrode 640 may be positioned closer to the inner side surface of the case body 620 than the first electrode 610. In addition, the three-electrode coin cell may further include a wire 650 having one end electrically connected to the reference electrode 640, and another end (e.g., an opposite end) positioned outside the case body 620.

In an embodiment, the three-electrode coin cell may further include the insulating member 660. The insulating member 660 may include a first insulating portion 662 in contact with an inner side surface of the case body 620, and a second insulating portion 664 protruding from the first insulating portion 662 toward the inside of the case body 620 (e.g., toward the first electrode 610). In this case, the wire 650 may extend to the outside through a space between the inner side surfaces of the first insulating portion 662 and the case body 620. In addition, a vertical level of an upper surface of the first insulating portion 662 may be equal to or greater than a vertical level of an upper surface of the side wall of the case body 620.

In an embodiment, a single separator 670 may be placed on the first electrode 610. In this case, one end of the single separator 670 may be disposed on a lower portion of the second insulating portion 664. In addition, at least a portion of the second insulating portion 664 may be positioned on at least a portion of the reference electrode 640.

A second electrode is not shown in FIG. 6 for convenience of illustration, but the second electrode may be placed on the separator 670.

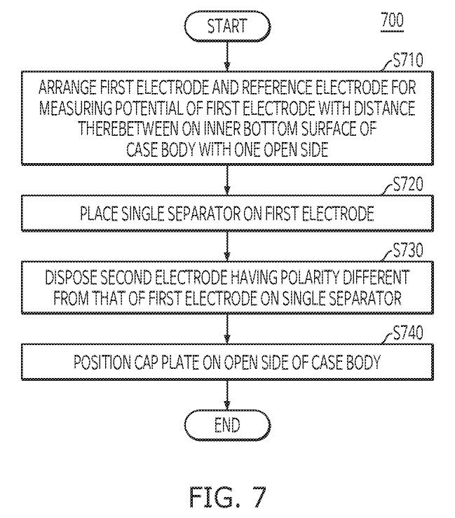

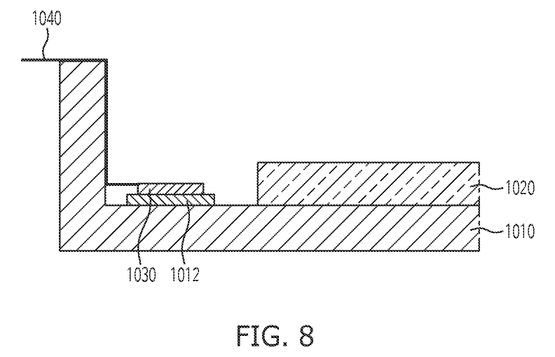

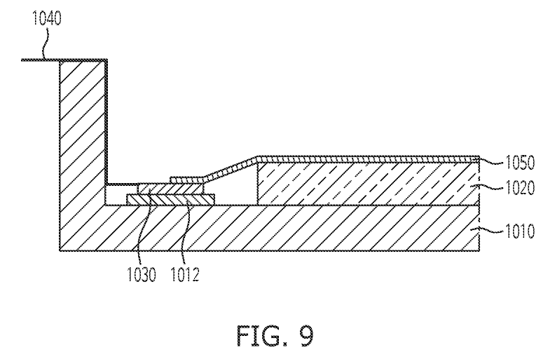

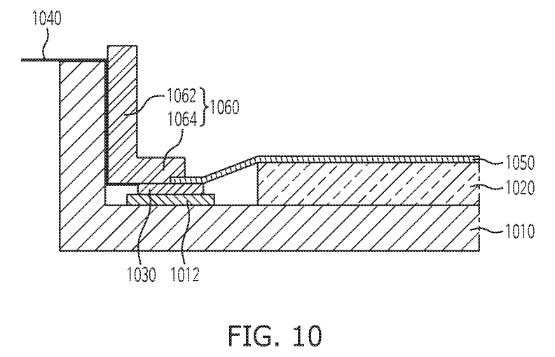

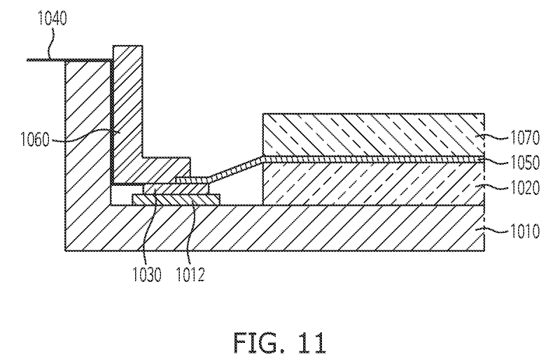

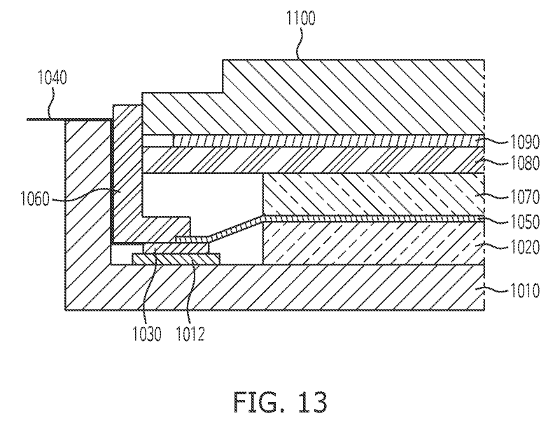

FIG. 7 is a flowchart showing an example of a method 700 of manufacturing a three-electrode coin cell according to an embodiment of the present disclosure. FIG. 8 is a schematic diagram illustrating an example in which a first electrode and a reference electrode are located on an inner bottom surface of a case body according to an embodiment of the present disclosure. FIG. 9 is a schematic diagram illustrating an example in which a single separator is located on a first electrode according to an embodiment of the present disclosure. FIG. 10 is a schematic diagram illustrating an example in which an insulating member is located according to an embodiment of the present disclosure. FIG. 11 is a schematic diagram illustrating an example in which a second electrode is located on a separator according to an embodiment of the present disclosure. FIG. 12 is a schematic diagram illustrating an example in which a spacer and an elastic member are located according to an embodiment of the present disclosure. FIG. 13 is a schematic diagram illustrating an example in which a cap plate is located on an open surface of a case body according to an embodiment of the present disclosure. For example, FIGS. 8 to 13 are schematic diagrams showing examples of some processes of the method 700 of manufacturing a three-electrode coin cell.

In an embodiment, the method 700 of manufacturing a three-electrode coin cell may start, and a first electrode and a reference electrode for measuring a potential of the first electrode with a distance therebetween may be arranged on an inner bottom surface of a case body with one open side (S710). In an embodiment, referring to FIG. 8, the first electrode 1020 and a reference electrode 1030 for measuring the potential of the first electrode 1020 may be spaced apart from each other on the inner bottom surface of a case body 1010. In more detail, an insulating coating layer 1012 may be formed on the inner bottom surface of the case body 1010 at a distance from the first electrode 1020. In addition, the reference electrode 1030 may be placed on the insulating coating layer 1012.

In an embodiment, one end of a wire 1040 may be connected to the reference electrode 1030, and another end (e.g., an opposite end) thereof may be positioned outside the case body 1010. The wire 1040 may include a first wire connected to the reference electrode 1030, and a second wire connected to the first wire and positioned adjacent to the case body 1010. In other words, the second wire may extend along an inner surface of a side wall of the case body 1010 from the first wire, and may be connected to an external device, such as the potential measuring device (e.g., see 230 in FIG. 2), through an upper portion of the side wall of the case body 1010. In addition, in order to be insulated from the case body 1010, the outer surface of the second wire may be coated with an insulating material.

Referring to FIG. 7, a single separator may be placed on (e.g., may be arranged on) the first electrode (S720). In an embodiment, referring to FIG. 9, a separator 1050 may be positioned on the first electrode 1020. In this case, at least a portion of one end of the separator 1050 may be placed on the reference electrode 1030.

In an embodiment, referring to FIG. 10, the case body 1010 may further accommodate an insulating member 1060. The insulating member 1060 may include a first insulating portion 1062 in contact with an inner side surface of the case body 1010, and a second insulating portion 1064 protruding from the first insulating portion 1062 toward the inside of the case body 1010 (e.g., toward the first electrode 1020). The second insulating portion 1064 may protrude from a lower portion of the first insulating portion 1062 toward the inside of the case body 1010. In addition, at least a portion of the second insulating portion 1064 may be disposed on at least a portion of the reference electrode 1030. Further, one end of the single separator 1050 may be placed on the lower portion of the second insulating portion 1064 of the insulating member 1060.

Referring to FIG. 7, a second electrode having a polarity different from that of the first electrode may be disposed on (e.g., may be placed on) the single separator (S730). In an embodiment, referring to FIG. 11, the second electrode 1070 having a polarity different from that of the first electrode 1020 may be positioned on the single separator 1050.

In an embodiment, referring to FIG. 12, a spacer 1080 may be placed on the second electrode 1070. The spacer 1080 may suppress a flow of the first electrode 1020 and the second electrode 1070, thereby providing a structural stability of the three-electrode coin cell. In addition, an elastic member 1090 may be disposed on the spacer 1080. The elastic member 1090 may maintain or substantially maintain a pressure inside the cell in response to a volume change that may occur when the components in the three-electrode coin cell expand or contract. For example, the elastic member 1090 may be a wave spring, but the present disclosure is not limited thereto.

Referring to FIG. 7, a cap plate may be positioned on (e.g., may be placed on) the open side of the case body (S740), and the method 700 may end. In an embodiment, referring to FIG. 13, a cap plate 1100 may be arranged on the open side of the case body 1010 to seal the case body 1010. In this case, at least a portion of the insulating member 1060 may be positioned between the cap plate 1100 and the case body 1010, so that the cap plate 1100 may seal the case body 1010 without coming into contact with the case body 1010. In addition, the wire 1040 may pass through the space between the side walls of the insulating member 1060 and the case body 1010. In this case, the diameter of the wire 1040 may be 0.1 mm or less to prevent or substantially prevent a leakage of an electrolyte inside the three-electrode coin cell, which has been sealed.

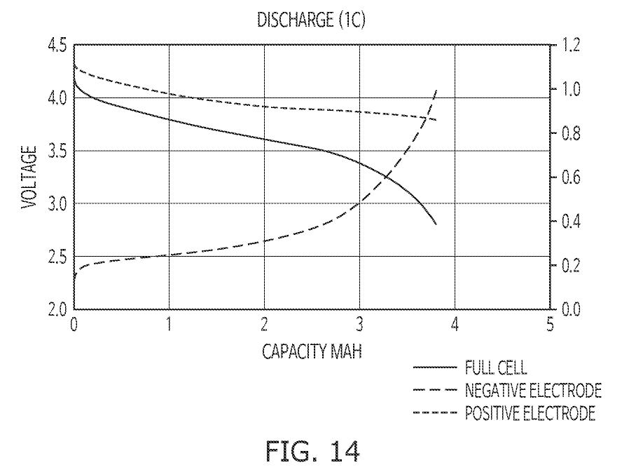

FIG. 14 is a graph illustrating an example of an output voltage profile using a three-electrode coin cell according to an embodiment of the present disclosure. In other words, FIG. 14 shows an example of a profile of a voltage output by a three-electrode coin cell according to an embodiment of the present disclosure.

In an embodiment, a reference electrode of the three-electrode coin cell according to an embodiment of the present disclosure may be horizontally spaced apart from a working electrode on a bottom surface of a case. Accordingly, because there may be no separator between the reference electrode and the working electrode, it may be possible to more accurately measure the voltage of the working electrode through the reference electrode.

Referring to FIG. 14, a noise may be reduced in the profile of the voltage output by the three-electrode coin cell according to an embodiment of the present disclosure. In addition, as the reference electrode may not be arranged between the working electrode and a counter electrode, an interference and side reactions of the reference electrode may decrease. As a result, a high charge/discharge rate (C-rate) may be secured, and/or the voltage of the working electrode may be stably measured even in multiple experiments.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

What is claimed is:

1. A three-electrode coin cell, comprising:
a first electrode;
a second electrode having a polarity different from that of the first electrode;
a reference electrode configured to measure a potential of the first electrode;
a case body accommodating the first electrode, the second electrode, and the reference electrode, and having one open side; and
a cap plate on the open side of the case body,
wherein the first electrode and the reference electrode are spaced from each other on an inner bottom surface of the case body.

2. The three-electrode coin cell as claimed in claim 1, further comprising an insulating coating layer on the inner bottom surface of the case body,
wherein the reference electrode is located on the insulating coating layer.

3. The three-electrode coin cell as claimed in claim 2, wherein an area of the insulating coating layer is wider than an area of the reference electrode.

4. The three-electrode coin cell as claimed in claim 1, wherein an area of the reference electrode is 4 mm² or less.

5. The three-electrode coin cell as claimed in claim 1, wherein a distance between the first electrode and the reference electrode is 0.5 mm or less.

6. The three-electrode coin cell as claimed in claim 1, wherein the reference electrode is closer to an inner side surface of the case body than the first electrode.

7. The three-electrode coin cell as claimed in claim 1, further comprising a single separator between the first electrode and the second electrode,
wherein the second electrode is located on the single separator and overlaps with the first electrode.

8. The three-electrode coin cell as claimed in claim 1, further comprising a wire having one end connected to the reference electrode, and another end located outside the case body.

9. The three-electrode coin cell as claimed in claim 8, wherein the wire comprises:
a first wire connected to the reference electrode; and
a second wire connected to the first wire, and located adjacent to the case body, and
wherein an outer surface of the second wire is coated with an insulating material.

10. The three-electrode coin cell as claimed in claim 9, wherein a portion of the reference electrode is folded as a folded portion of the reference electrode, and
wherein the first wire is connected to the folded portion.

11. The three-electrode coin cell as claimed in claim 8, wherein a diameter of the wire is 0.1 mm or less.

12. The three-electrode coin cell as claimed in claim 1, further comprising an insulating member comprising:
a first insulating portion in contact with an inner side surface of the case body; and
a second insulating portion protruding from the first insulating portion toward an inside of the case body.

13. The three-electrode coin cell as claimed in claim 12, wherein at least a portion of the second insulating portion is located on at least a portion of the reference electrode.

14. The three-electrode coin cell as claimed in claim 12, further comprising a single separator on the first electrode,
wherein an end of the single separator is on a lower portion of the second insulating portion.

15. A method of manufacturing a three-electrode coin cell, comprising:
arranging a first electrode and a reference electrode with a distance therebetween on an inner bottom surface of a case body having one open side, the reference electrode for measuring a potential of the first electrode;
placing a single separator on the first electrode;
disposing a second electrode having a polarity different from that of the first electrode on the single separator; and
positioning a cap plate on the open side of the case body.

16. The method as claimed in claim 15, wherein the arranging of the first electrode and the reference electrode comprises:
forming an insulating coating layer on the inner bottom surface of the case body; and
placing the reference electrode on the insulating coating layer.

17. The method as claimed in claim 15, further comprising connecting one end of a wire to the reference electrode, and positioning another end of the wire outside the case body.

18. The method as claimed in claim 17, wherein the wire comprises:
a first wire connected to the reference electrode; and
a second wire connected to the first wire, and located adjacent to the case body, and
wherein an outer surface of the second wire is coated with an insulating material.

19. The method as claimed in claim 15, further comprising accommodating an insulating member into the case body after the placing of the single separator,
wherein the insulating member comprises:
a first insulating portion in contact with an inner side surface of the case body; and
a second insulating portion protruding from the first insulating portion toward an inside of the case body.

20. The method as claimed in claim 19, wherein the accommodating of the insulating member into the case body comprises placing an end of the single separator on a lower portion of the second insulating portion of the insulating member.
